(19) United States
(12) Patent Application Publication
(10) Pub. No.: US 2010/0278395 A1
(43) Pub. Date: Nov. 4, 2010

(54) Automatic backlit face detection

(76) Inventor: Jonathan Yen, San Jose, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/387,540

(22) Filed: May 4, 2009

(51) Int. Cl. G06K 9/00

(52) U.S. Cl. 382/118

(57) ABSTRACT

The subject application is directed to a system and method for detecting facial areas from an image having a relatively light background. Image data is received including at least one candidate facial region. A candidate facial region is isolated from the image data as is a subportion of an interior of the candidate facial region. A size of the subportion is compared relative to a preselected threshold size value, a luminance value of the subportion is compared with a preselected darkness threshold value, and a facial recognition signal is generated corresponding to a detected facial region in accordance with an output of the size comparison and the luminance comparison.

### BACKGROUND OF THE INVENTION

The subject application is directed generally to detection of facial areas in electronic images. The application is particularly applicable to detection or correction of facial areas that are relatively dark, such as might be expected with a backlit image.

Captured images, such as with photographs, often include human faces. With most images, the human or humans depicted are of most interest to a viewer. In certain conditions, particularly in situations wherein a facial area is dark relative to a background, features or integrity of the facial image are lost. For this reason, many photographers will seek to avoid such situations and position subjects such that the lighting is behind the photographer. However, in many situations, there may be little or no control of lighting relative to a photographed subject. For example, a photographer's position may be fixed relative to the sun, or other lighting, and the subject, such that the subject is positioned in front of a light source. In this instance, there is no option but to take a picture with the understanding that integrity of a resultant image may be sacrificed.

### SUMMARY OF THE INVENTION

In accordance with one embodiment of the subject application, there is provided a system and method for detecting facial areas from an image having a relatively light background. Image data is received including at least one candidate facial region. A candidate facial region is isolated from the image data as is a subportion of an interior of the candidate facial region. A size of the subportion is compared relative to a preselected threshold size value, a luminance value of the subportion is compared with a preselected darkness threshold value, and a facial recognition signal is generated corresponding to a detected facial region in accordance with an output of the size comparison and the luminance comparison.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The patent or application file contains at least one drawing executed in color. Copies of this patent or patent application publication with color drawings will be provided by the Office upon request and payment of the necessary fee The subject application is described with reference to certain figures, including:

FIG. 1 is an overall diagram of a system for detecting facial areas from images having a relatively light background according to one embodiment of the subject application;

FIG. 2 is a block diagram illustrating device hardware for use in the system for detecting facial areas from images having a relatively light background according to one embodiment of the subject application;

FIG. 3 is a functional diagram illustrating the device for use in the system for detecting facial areas from images having a relatively light background according to one embodiment of the subject application;

FIG. 4 is a block diagram illustrating controller hardware for use in the system for detecting facial areas from images having a relatively light background according to one embodiment of the subject application;

FIG. 5 is a functional diagram illustrating the controller for use in the system for detecting facial areas from images having a relatively light background according to one embodiment of the subject application;

FIG. 6 is a diagram illustrating a workstation for use in the system for detecting facial areas from images having a relatively light background according to one embodiment of the subject application;

FIG. 7 is a block diagram illustrating the system for detecting facial areas from images having a relatively light background according to one embodiment of the subject application;

FIG. 8 is a functional diagram illustrating the system for detecting facial areas from images having a relatively light background according to one embodiment of the subject application;

FIG. 9 is a flowchart illustrating a method for detecting facial areas from images having a relatively light background according to one embodiment of the subject application;

FIG. 10 is a flowchart illustrating a method for detecting facial areas from images having a relatively light background according to one embodiment of the subject application;

FIG. 11 is an example of an input image and associated corrected image in accordance with the system for detecting facial areas from images having a relatively light background according to one embodiment of the subject application;

FIG. 12 is an example of an input image, corrected image, and cropped facial region in accordance with the system for detecting facial areas from images having a relatively light background according to one embodiment of the subject application;

FIG. 13 is an example normalized histogram of an input image in accordance with the system for detecting facial areas from images having a relatively light background according to one embodiment of the subject application;

FIG. 14 is an example of an accumulated and normalized histogram of an input image in accordance with the system for detecting facial areas from images having a relatively light background according to one embodiment of the subject application;

FIG. 15 is an example depicting a determined mid-point associated with the histogram of FIG. 14 in accordance with the system for detecting facial areas from images having a relatively light background according to one embodiment of the subject application;

FIG. 16 is an example illustrating a normalized histogram, its accumulated histogram, and mid-point in accordance with the system for detecting facial areas from images having a relatively light background according to one embodiment of the subject application;

FIG. 17 is an example histogram of an input image inclusive of associated noise in accordance with the system for detecting facial areas from images having a relatively light background according to one embodiment of the subject application;

FIG. 18 depicts a histogram having an adjusted mid-point via extreme intensity pixel value discarding of the input image of FIG. 17 in accordance with the system for detecting facial areas from images having a relatively light background according to one embodiment of the subject application;

FIG. 19 is an example depicting histogram data of an input image in accordance with the system for detecting facial areas from images having a relatively light background according to one embodiment of the subject application;

FIG. 20 is another example depicting histogram data of an input image in accordance with the system for detecting facial areas from images having a relatively light background according to one embodiment of the subject application;

FIG. 21 also depicts an example of histogram data associated with an input image in accordance with the system for detecting facial areas from images having a relatively light background according to one embodiment of the subject application; and

FIG. 22 is another example depicting an adjusted mid-point associated with histogram data of the input image of FIG. 21 in accordance with the system for detecting facial areas from images having a relatively light background according to one embodiment of the subject application.

### DETAILED DESCRIPTION OF THE PREFERRED EMBODIMENT

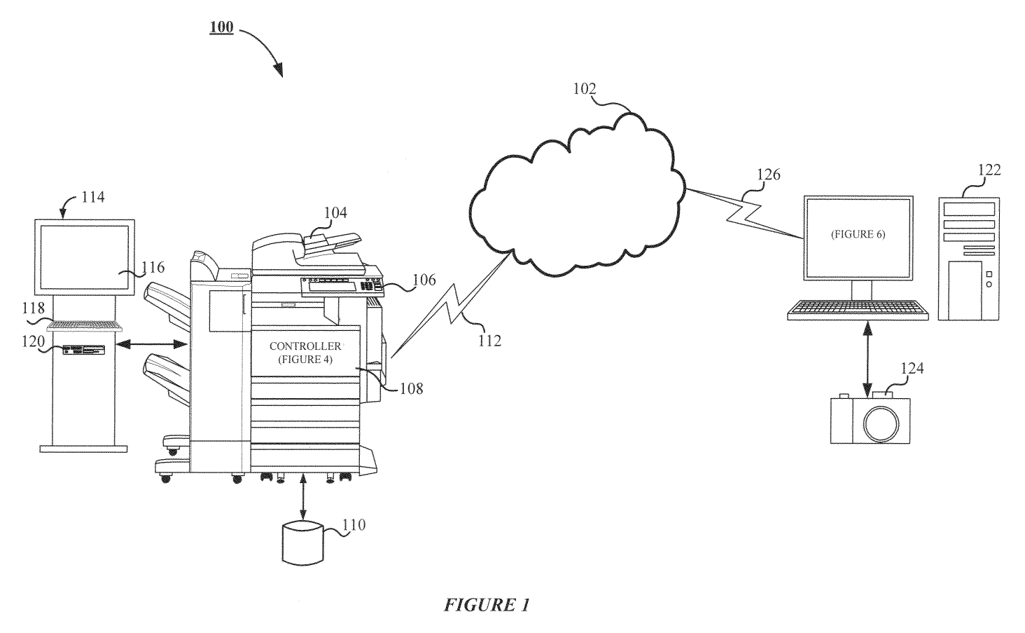

The subject application is directed to a system and method for detecting facial areas in electronic images. In particular, the subject application is directed to a system and method for detection or correction of facial areas that are relatively dark, such as a backlit image. More particularly, the subject application is directed to a system and method for detecting facial areas from an image having a relatively light background. It will become apparent to those skilled in the art that the system and method described herein are suitably adapted to a plurality of varying electronic fields employing data detection and correction, including, for example and without limitation, communications, general computing, data processing, document processing, financial transactions, vending of products or services, or the like. The preferred embodiment, as depicted in FIG. 1, illustrates a document or imaging processing field for example purposes only and is not a limitation of the subject application solely to such a field.

Referring now to FIG. 1, there is shown an overall diagram of a type system 100 for detecting facial areas from images having a relatively light background in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

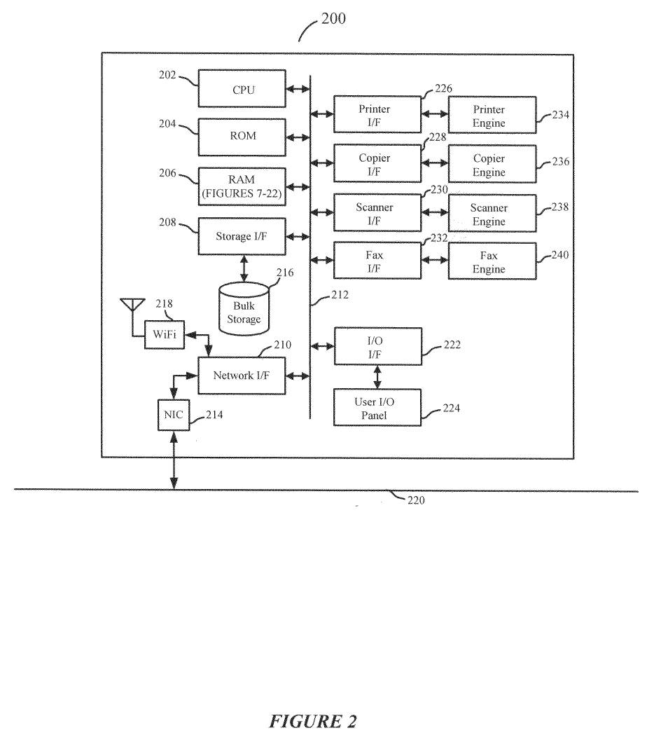

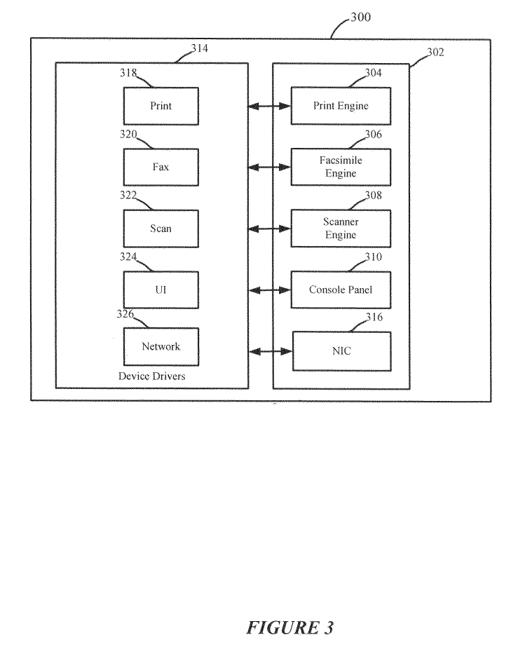

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

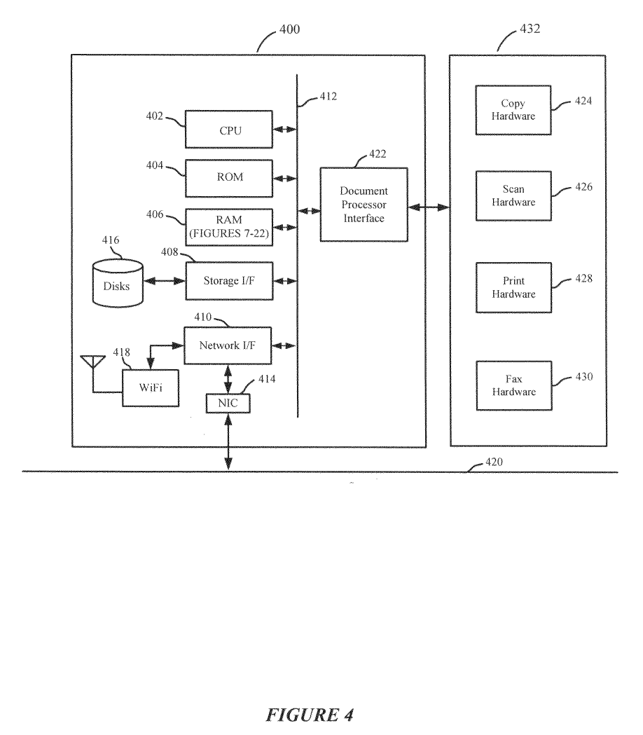

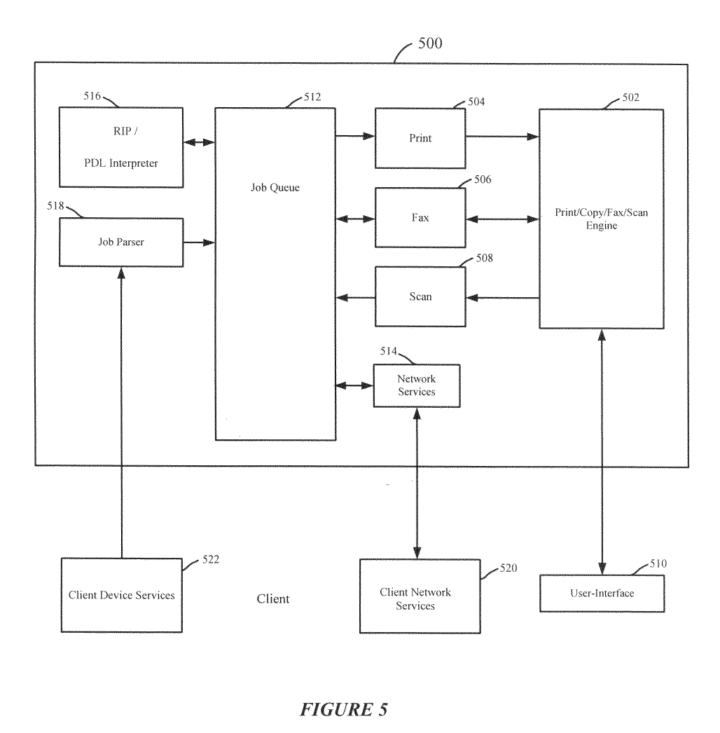

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for detecting facial areas from images having a relatively light background. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, cellular telephone data, pre-set payment data, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like.

FIG. 1 also illustrates a kiosk 114 communicatively coupled to the document processing device 104, and in effect, the computer network 102. It will be appreciated by those skilled in the art that the kiosk 114 is capable of being implemented as a separate component of the document processing device 104, or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116, and a user input device 118. As will be understood by those skilled in the art the kiosk 114 is capable of implementing a combination user input device/display, such as a touchscreen interface. According to one embodiment of the subject application, the kiosk 114 is suitably adapted to display prompts to an associated user, receive document processing instructions from the associated user, receive payment data, receive selection data from the associated user, and the like. Preferably, the kiosk 114 includes a magnetic card reader, conventional bar code reader, or the like, suitably adapted to receive and read payment data from a credit card, coupon, debit card, or the like.

The system 100 of FIG. 1 also includes a portable storage device reader 120, coupled to the kiosk 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

Also depicted in FIG. 1 is a user device, illustrated as a computer workstation 122 in data communication with the computer network 102 via a communications link 126. It will be appreciated by those skilled in the art that the computer workstation 122 is shown in FIG. 1 as a workstation computer for illustration purposes only. As will be understood by those skilled in the art, the computer workstation 122 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the workstation 122 further includes software, hardware, or a suitable combination thereof configured to interact with the document processing device 104, or the like.

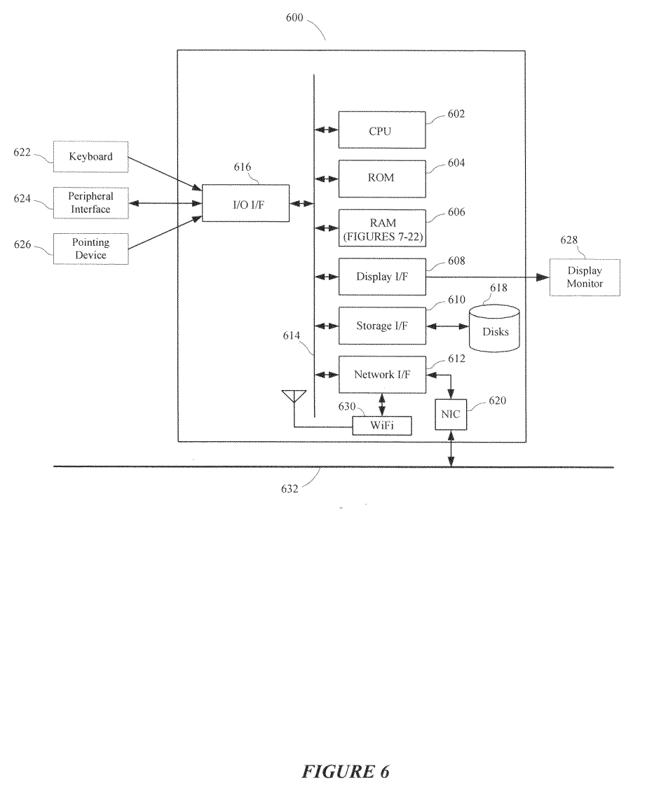

The communications link 126 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the computer workstation 126 is suitably adapted to provide document data, job data, user interface data, image data, monitor document processing jobs, employ thin-client interfaces, generate display data, generate output data, or the like, with respect to the document rendering device 104, or any other similar device coupled to the computer network 102. The functioning of the computer workstation 126 will better be understood in conjunction with the block diagram illustrated in FIG. 6, explained in greater detail below.

Additionally, the system 100 of FIG. 1 depicts an image capture device, illustrated as a digital camera 124 in data communication with the workstation 122. The skilled artisan will appreciate that the camera 124 is representative of any image capturing device known in the art, and is capable of being in data communication with the document processing device 104, the workstation 122, or the like. In accordance with one embodiment of the subject application, the camera 124 is capable of functioning as a portable storage device via which image data is received by the workstation 122, as will be understood by those skilled in the art.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the computer workstation 122, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

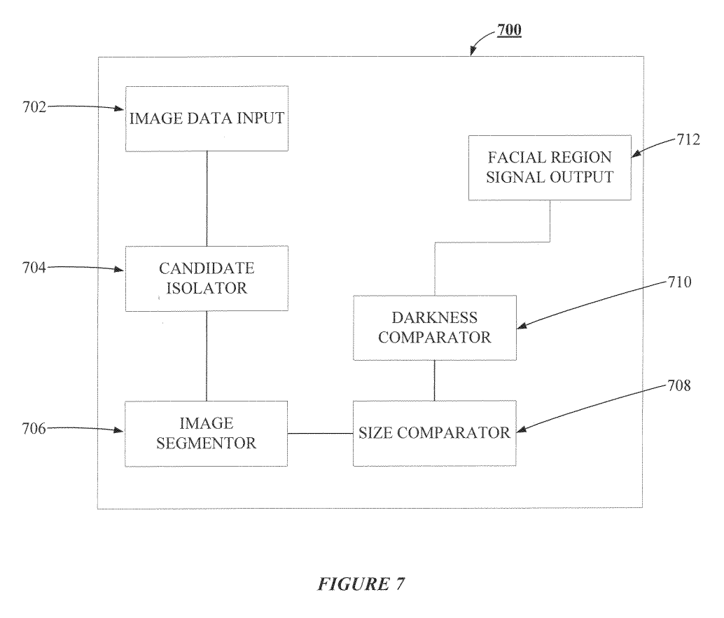

Turning now to FIG. 7, illustrated is a block diagram of a system 700 for detecting facial areas from images having a relatively light background in accordance with one embodiment of the subject application. The system 700 includes an image data input 702 operable to receive image data that includes at least one candidate facial region. The system 700 further includes a candidate isolator 704 configured to isolate a candidate facial region from the image received via the input 702. The system 700 also incorporates an image segmentor 706, which is capable of isolating a subportion of an interior of the candidate facial region.

A size comparator 708 is then employed in the system 700 so as to compare a size of the subportion relative to a preselected threshold size value. The system 700 also includes a darkness comparator 710 operable to compare a luminance value of the subportion with a preselected darkness threshold value. The system 700 further incorporates a facial region signal output 712 that is configured to output a signal corresponding to a detected facial region based upon the outputs of the size comparator 708 and the darkness comparator 710.

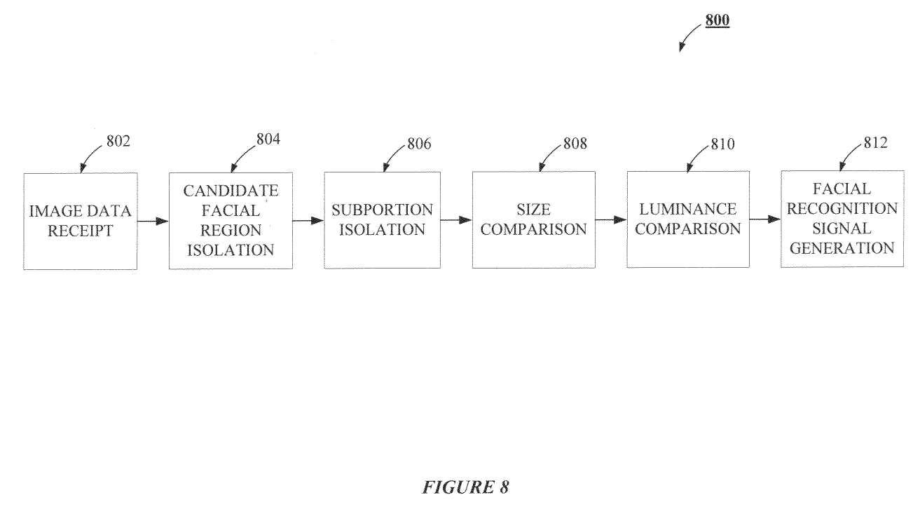

Referring now to FIG. 8, there is shown a functional diagram illustrating the system 800 for detecting facial areas from images having a relatively light background in accordance with one embodiment of the subject application. As shown in FIG. 8, image data receipt 802 first occurs of image data that includes at least one candidate facial region. Candidate facial region isolation 804 is then performed one a candidate facial region from the received image data. Subportion isolation 806 is then performed of a subportion of the interior of the isolated candidate facial region.

A size comparison 808 is then made of the size of the subportion relative to a preselected threshold size value. A luminance comparison 810 is then performed between a luminance value of the isolated subportion and a preselected darkness threshold value. Next, facial recognition signal generation 812 occurs corresponding to a detected facial region in accordance with an output of the size comparison 808 and the luminance comparison 810.

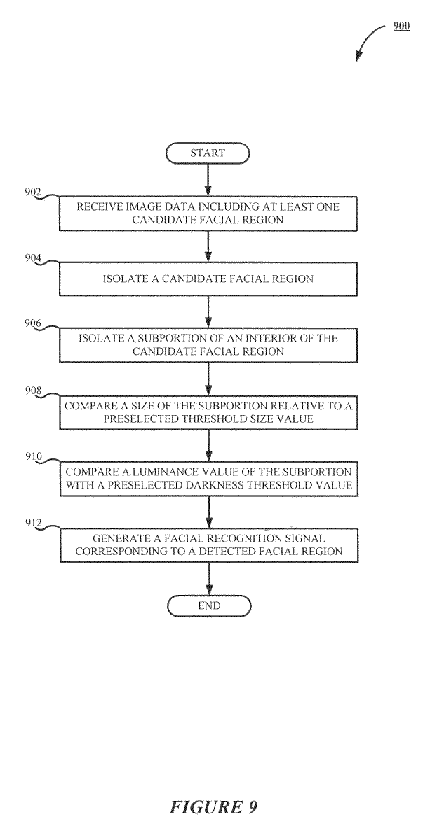

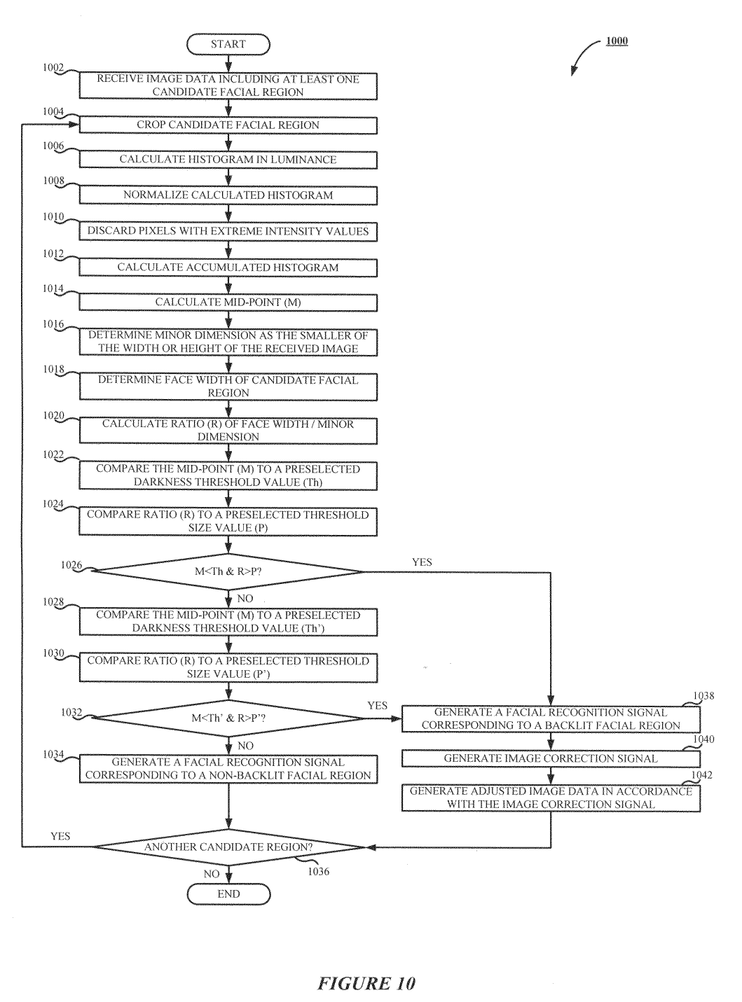

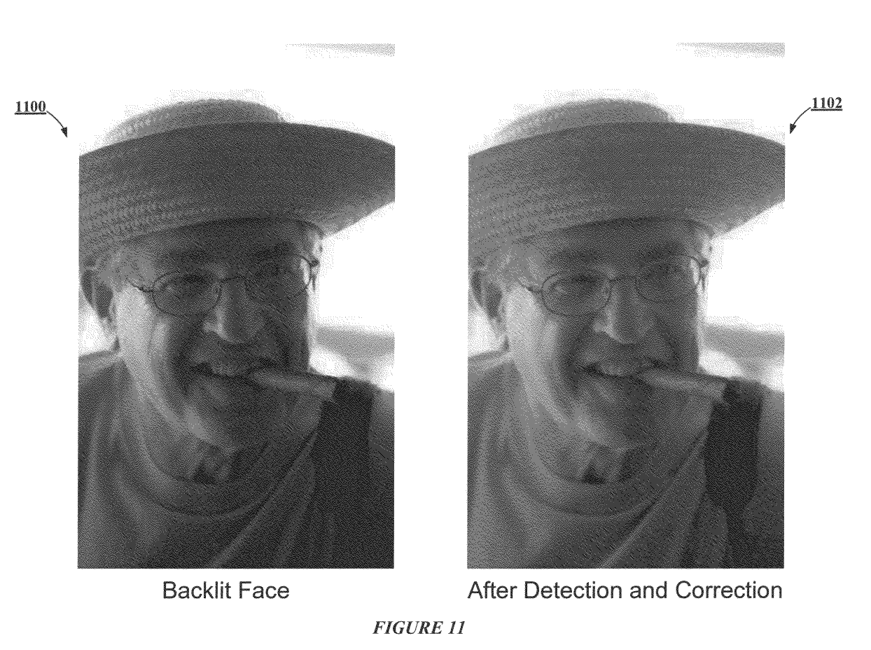

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10, as well as the example implementations illustrated in FIGS. 11-22. Turning now to FIG. 9, there is shown a flowchart 900 illustrating a method for detecting facial areas from images having a relatively light background in accordance with one embodiment of the subject application. Beginning at step 902, image data is received that includes at least one candidate facial region. A candidate facial region is then isolated from the received image data at step 904.

Operations then proceed to step 906, whereupon a subportion of an interior of the candidate facial region is isolated. At step 908, a size of the subportion is compared relative to a preselected threshold size value. A luminance value of the subportion is then compared with a preselected darkness threshold value at step 910. At step 912, a facial recognition signal is generated corresponding to a detected facial region in accordance with an output of the size comparison at step 908 and the luminance comparison at step 910.

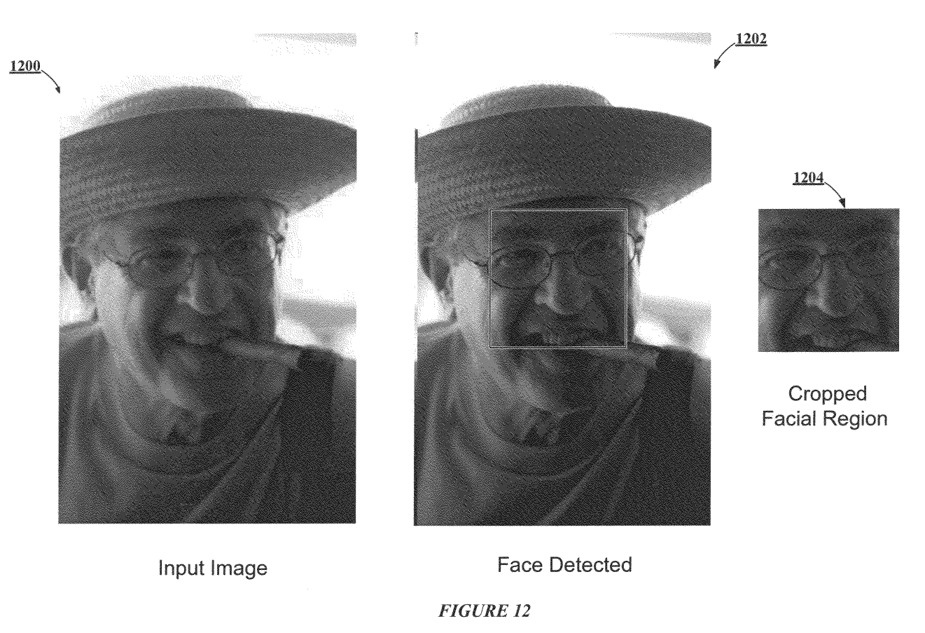

Referring now to FIG. 10, there is shown a flowchart 1000 illustrating a method for detecting facial areas from images having a relatively light background in accordance with one embodiment of the subject application. The methodology of FIG. 10 begins at step 1002, whereupon image data that includes at least one candidate facial region is received by the controller 108, the workstation 122, or other suitable processing device. It will be appreciated by those skilled in the art that such image data is capable of being received via the digital camera 124, via a portable storage medium, via an electronic data communication, via the performance of a scanning operation, or the like. FIG. 11 illustrates an example input image 1100 having a backlit face and the resulting output image 1102 of the backlit face detection and correction in accordance with one embodiment of the subject application. A candidate facial region is then cropped, or isolated, by the controller 108, workstation 122, or other suitable processing device at step 1004. FIG. 12 depicts an input image 1200, the detection of a candidate facial region 1202 and the cropping, or isolating of the detected candidate facial region 1204. It will be appreciated by those skilled in the art that the face in the input image 1200 is located by a face detector, (hardware, software, or a combination thereof adapted for detection of faces in images) typically with a detection rectangle, which is then cropped 1204.

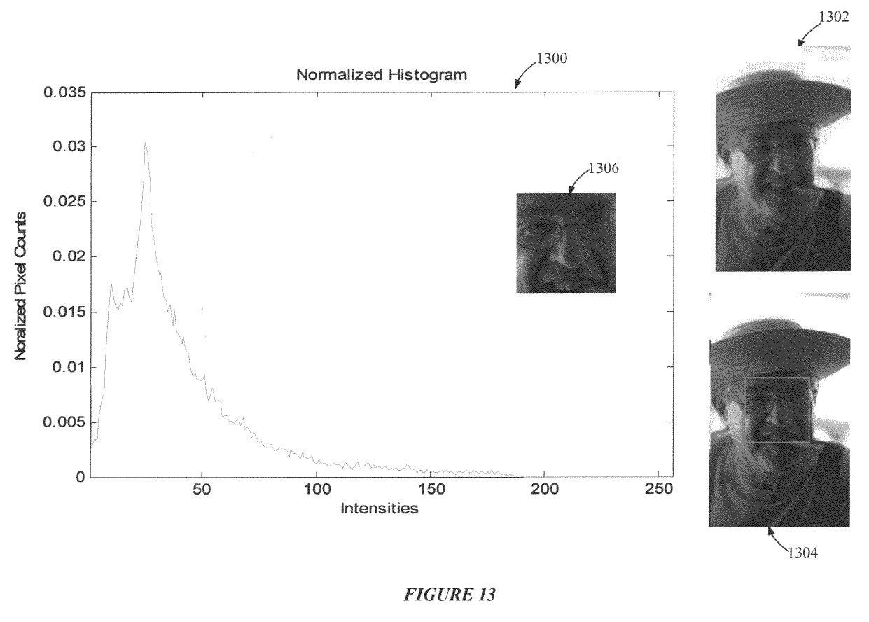

A histogram in luminance is then calculated at step 1006 corresponding to a received input image via the controller 108, workstation 122, or other suitable processing device known in the art. A normalized histogram in luminance is then calculated at step 1008. FIG. 13 illustrates a normalized histogram 1300 corresponding to the input image 1302, facial candidate image 1304, and cropped facial region 1306. At step 1010, pixels having extreme intensity values, e.g. values too close to 0 or too close to 255, are discarded. In accordance with one example embodiment of the subject application, in 8-bit code values ranging from 0 to 255, those pixels having extreme intensity values greater than 252 or values less than 3 are discarded. It will be appreciated by those skilled in the art that such discarding of pixels having these extreme values reduces any noise in the candidate facial region.

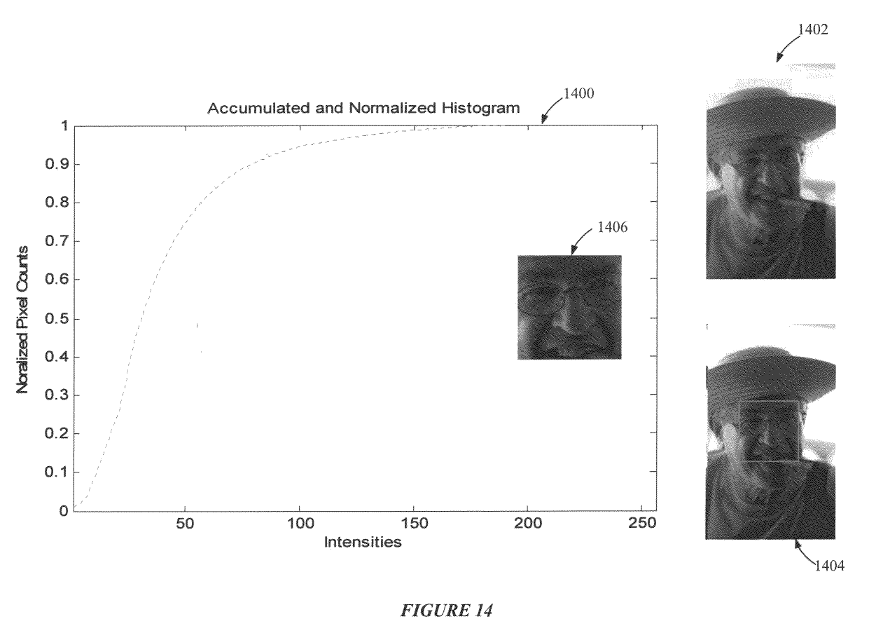

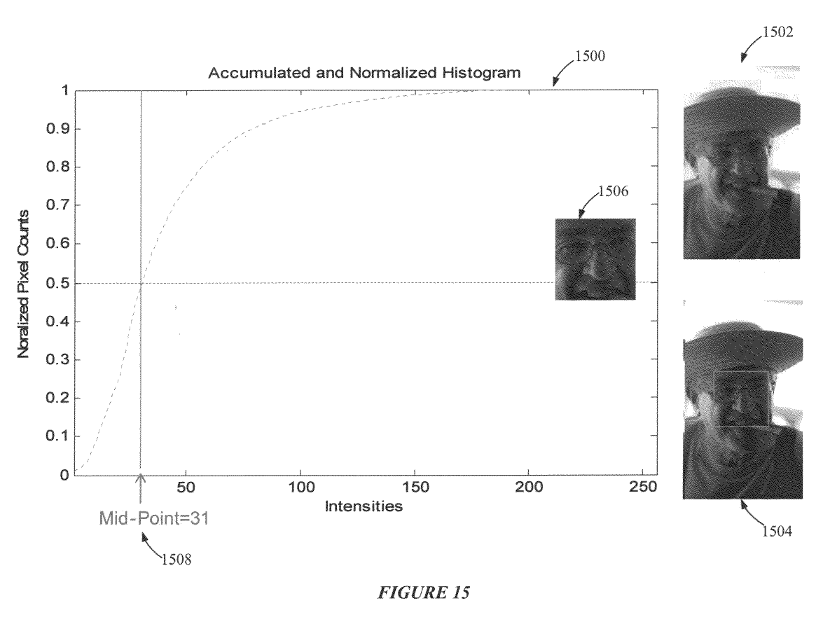

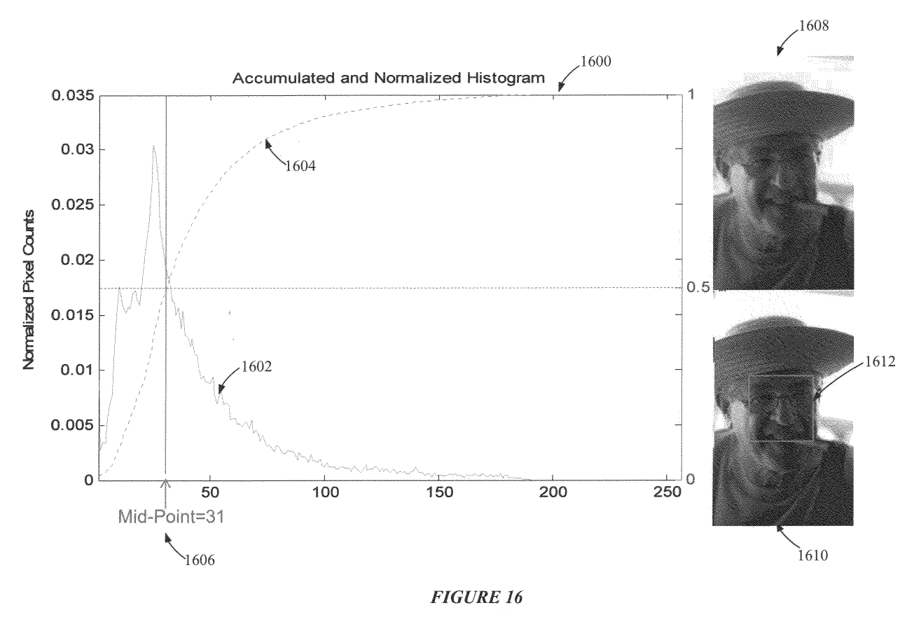

At step 1012, the accumulated normalized histogram is calculated corresponding to the cropped facial region by the controller 108, the workstation 122, or other processing device as will be appreciated by those skilled in the art. FIG. 14 depicts an example accumulated and normalized histogram 1400 associated with the input image 1402, input image subject to facial detection 1404, and the cropped candidate facial region 1406. A luminance value, i.e. a mid-point (M), is then calculated at step 1014 corresponding to the intensity value at which the accumulated histogram reaches 50%. FIG. 15 illustrates the accumulated and normalized histogram 1500 from the cropped facial region 1506 detected in the image 1504 corresponding to the input image 1502. The mid-point 1508 of FIG. 15 corresponds to an intensity value of 31 at which the accumulated histogram reaches 50%. FIG. 16 shows a graph 1600 illustrating the normalized histogram in luminance 1602, its accumulated histogram 1604 and the mid-point 1606 of the cropped facial region 1612 of facial detection image 1610 corresponding to the received input image 1608.

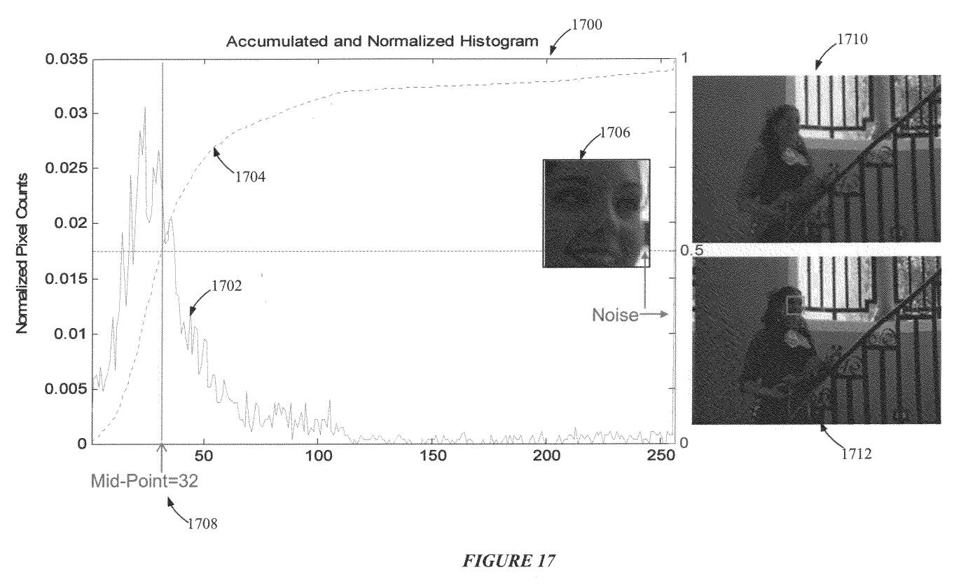

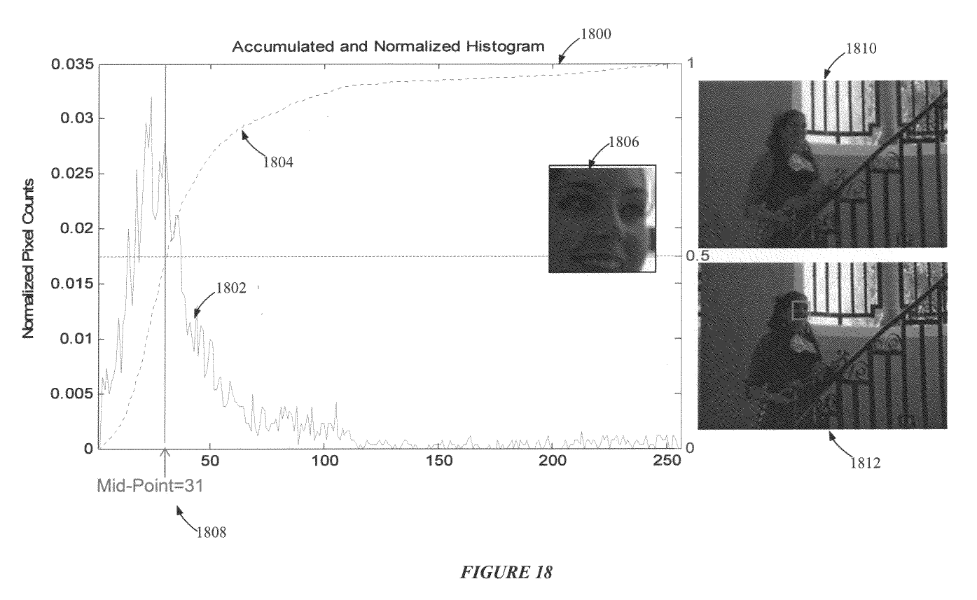

It will be understood by those skilled in the art that when a facial region contains noise, for example, extreme dark or extreme bright intensities that do not belong to natural human facial regions, the resultant mid-point calculation is likely to be biased. FIG. 17 shows an example of background noise included in the facial region 1706 in the facial detection results 1712 corresponding to the input image 1710. As depicted in FIG. 17, the graph 1700 illustrates a normalized histogram 1702 and accumulated histogram 1704 corresponding to the facial region 1706. The graph 1700 further indicates that the mid-point 1708 calculated for this region 1706 is M=32, due to the noise present in the region 1706 shown on the far left of the graph 1700. FIG. 18 shows the input image 1810 corresponding to the input image 1710 of FIG. 17 after discarding pixels having extreme intensity values. As shown in FIG. 18, the graph depicts the normalized histogram in luminance 1802 and accumulated histogram in luminance 1804 after noise reduction. The resulting mid-point (M) corresponding to the detected facial region 1806 (shown in the facial detection image 1812) has been adjusted (M=31) by discarding the pixels with extreme intensity values.

Returning to FIG. 10, after calculation of the mid-point (M) at step 1014, flow proceeds to step 1016, whereupon the minor dimension is determined as the smaller of the width and height of the received image. At step 1018, a width in pixels of the candidate facial region is determined. The ratio (R) of the face width over the minor dimension is then calculated at step 1020. According to one embodiment of the subject application, the ratio (R) is calculated as a percentage of the pixels (size) of the input image. The mid-point (M) is then compared to a preselected darkness threshold value (Th) at step 1022. The ratio (R) is then compared to a preselected threshold size value (P) at step 1024. A determination is then made at step 1026 whether the mid-point (M) is less than the preselected threshold darkness value (Th) and the ratio (R) is greater than the preselected size threshold value P, i.e. M<Th and R>P. In accordance with one embodiment of the subject application, the threshold darkness value is generated in accordance with a plurality of previous facial candidate measurements, and the threshold size value is generated in accordance with the plurality of previous facial candidate measurements. According to such an embodiment, the threshold values used in the example embodiment described with respect to FIG. 10 are Th=41 and P=10%.

Upon a determination at step 1026 that the mid-point is less than the preselected darkness threshold value (Th) and the ratio (R) is greater than the preselected size threshold, i.e. the cropped facial region is dark enough and large enough, flow proceeds to step 1038. At step 1038, a facial recognition signal corresponding to an identified backlit facial region is generated by the controller 108, the workstation 122, or other suitable processing device implementing the methodology of FIG. 10. An image correction signal is then generated at step 1040 indicative of a correction to the cropped facial region so as to rectify the backlit appearance thereof. Adjusted image data is then generated at step 1042 in accordance with the image correction signal. A determination is then made at step 1036 whether another facial candidate region remains for processing in the input image. When no additional facial regions remain in the input image, operations with respect to FIG. 10 terminate. In the event that at least one additional facial candidate region has been isolated or identified via facial detection, operations return to step 1004, whereupon the at least one additional candidate facial region is cropped or isolated from the input image and the methodology of FIG. 10 continues thereafter as set forth above.

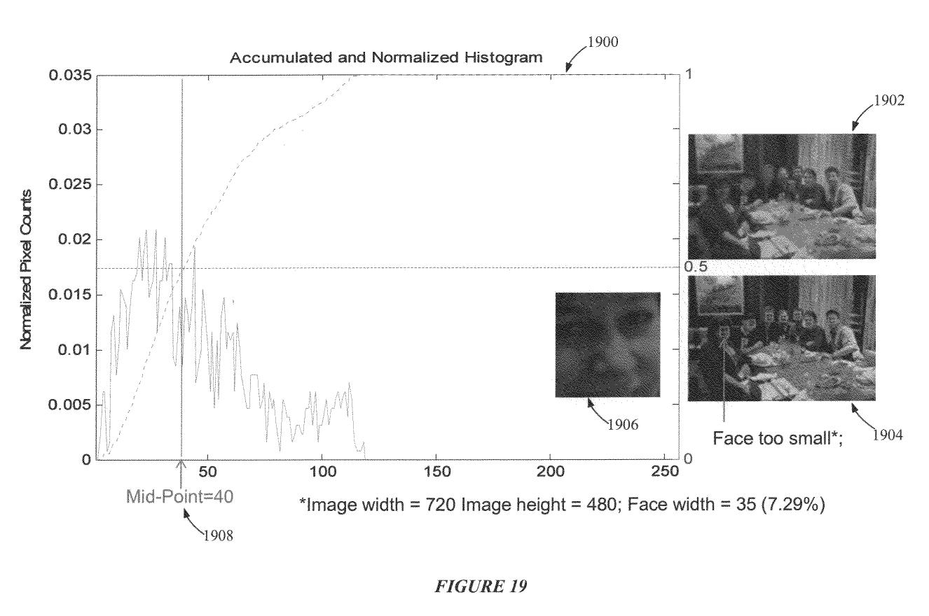

Returning to step 1026, when it is determined that the mid-point (M) is greater than or equal to the preselected darkness threshold value (Th) and/or the ratio (R) is less than or equal to the preselected size threshold value (P), flow proceeds to step 1028. FIG. 19 illustrates an example embodiment wherein the calculated mid-point (M) 1908 of the accumulated and normalized histogram 1900 for the input image 1902 is less than the predetermined threshold value Th, but the ratio (R) of the cropped facial region 1906 as illustrated in the detection image 1904 is not greater than the predetermined size threshold value (P). As will be appreciated by those skilled in the art, the size of the facial region 1906 illustrated in FIG. 19 is too small with respect to the predetermined threshold value P. At step 1028, the mid-point (M) is then compared to an adjusted darkness threshold value (Th′). The ratio (R) is then compared to an adjusted size threshold value (P′) at step 1030. Based upon previous facial candidate measurements, one embodiment of the subject application employs the following adjusted threshold values at step 1028 and step 1030, Th′=52, and P′=20%.

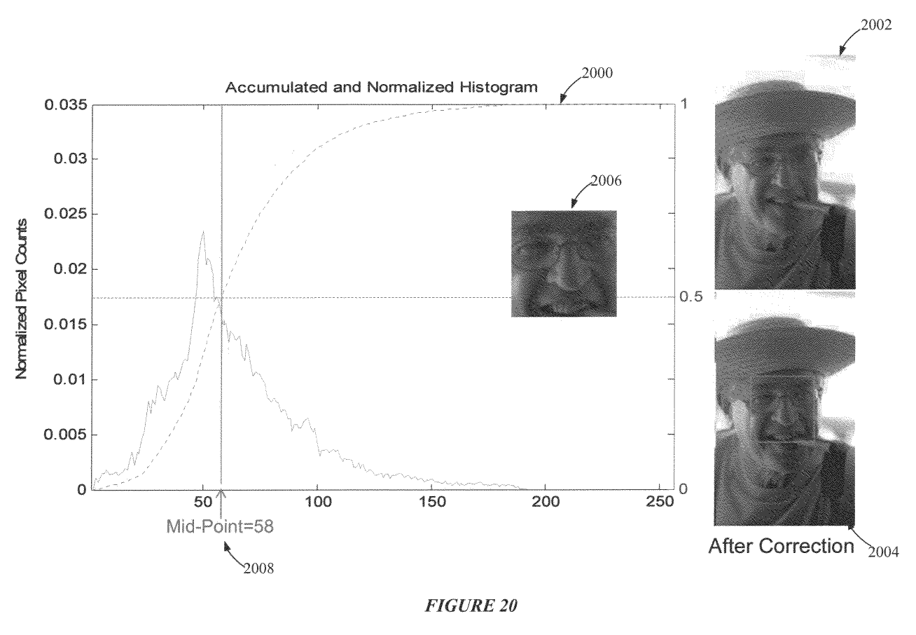

A determination is then made at step 1032 based upon the comparisons of steps 1028 and 1030 whether the mid-point (M) is less than the adjusted darkness threshold value (Th′) and the ratio (R) is greater than the adjusted size threshold value (P′), i.e. M<Th′ and R>P′. A positive determination at step 1032 prompts the generation of a facial recognition signal corresponding to a backlit facial region at step 1038. Operations continue thereafter with respect to steps 1040 through 1036 as set forth in greater detail above. FIG. 20 illustrates an accumulated and normalized histogram 2000 of the input image 2002 and post-image correction image 2004. As shown in FIG. 20, the cropped facial region 2006 has a mid-point 2008 (M) of M=58, which is above the preselected darkness threshold values Th and Th′, thus indicating that the facial region no longer qualifies as a backlit face.

When a negative determination is made at step 1032, flow proceeds to step 1034, whereupon a facial recognition signal corresponding to a non-backlit facial region is generated. As this facial region does not require adjustment or correction, flow progresses to step 1036, whereupon a determination is made whether another facial candidate region remains in the input image for processing. If another region remains, flow returns to step 1004. When no additional regions remain in the input image, operations with respect to FIG. 10 terminate.

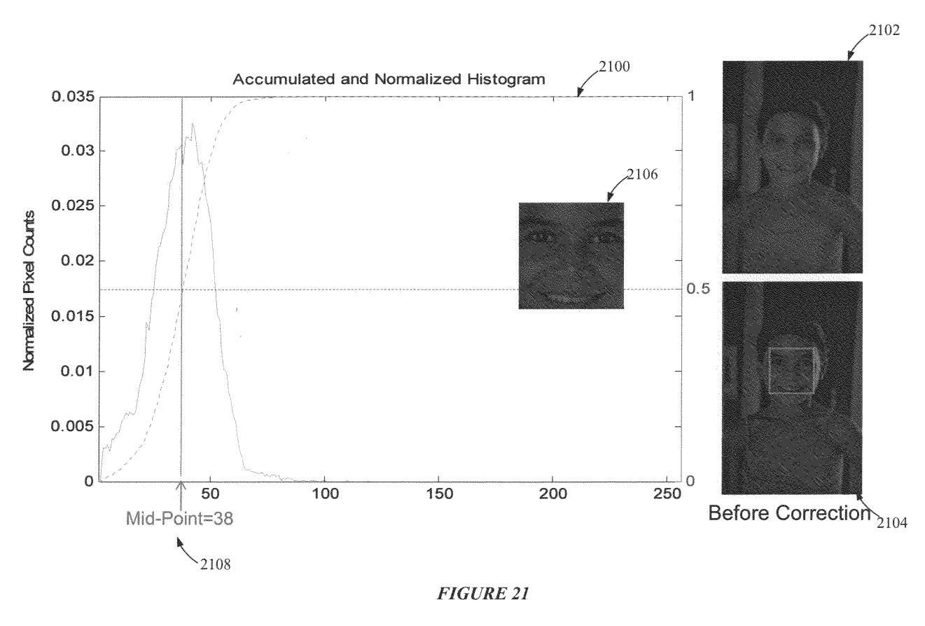

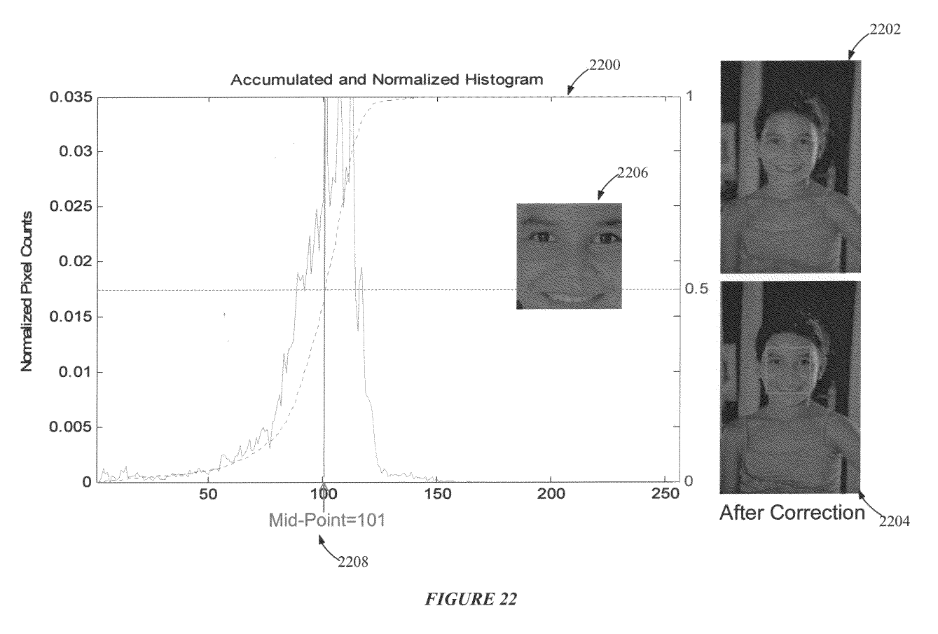

The skilled artisan will appreciate that the methodology of the subject application is also capable of being applied to detect poorly illuminated faces. A backlit face, as will be understood by those skilled in the art, is typically darker than its surroundings, i.e. a dark face can be as dark as its background. FIG. 21 illustrates an example wherein the input image 2102 includes a face (detected at 2104) that is as dark or darker than some or all of the background. The accumulated and normalized histogram in luminance 2100 of the facial region 2106 illustrates this example with the mid-point 2108 at M=38, indicative of a backlit facial region 2106. Following application of correction, the image region 2106 is no longer backlit. FIG. 22 depicts the post-correction input image 2202, the facial detection image 2204, the candidate facial region 2206, and the accumulated and normalized histogram 2200. The skilled artisan will appreciate that as shown in FIG. 22, the candidate region 2206 has a mid-point 2208 at M=101, well above the preselected threshold values Th and Th′ established via past measurements, and thus is indicative of a facial region 2206, which is not backlit.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for detecting facial areas from images having a relatively light background comprising:
an input operable to receive image data including at least one candidate facial region;
an isolator operable to isolate a candidate facial region from received image data;
an image segmentor operable to isolate a subportion of an interior of the candidate facial region;
a size comparator operable to compare a size of the subportion relative to a preselected threshold size value;
a darkness comparator operable to compare a luminance value of the subportion with a preselected darkness threshold value; and
a facial region signal output operable to output a signal corresponding to a detected facial region in accordance with an output of the size comparator and the darkness comparator.

2. The system of claim 1 further comprising:
a histogram generator operable to generate luminance histogram data of the subportion;
a normalizer operable to normalize the luminance histogram data; and
wherein the darkness comparator is further operable to compare normalized luminance histogram data with the preselected darkness threshold value.

3. The system of claim 2 further comprising:
a normalized histogram accumulator operable on the normalized histogram data;
a mid-point isolation system operable to isolate a mid-point of the normalized histogram data; and
wherein the darkness comparator is further operable to compare the mid-point to the preselected darkness threshold value.

4. The system of claim 3 further comprising:
a threshold size value generator operable to generate the threshold size value in accordance with a plurality of previous facial candidate portion measurements; and
a darkness threshold value generator operable to generate the darkness threshold value in accordance with the plurality of previous facial candidate portion measurements.

5. The system of claim 4 further comprising a correction signal generator operable to generate an image correction signal in accordance with an output of at least one of the size comparator and the darkness comparator.

6. The system of claim 5 further comprising an image adjustor operable to generate adjusted image data corresponding to received image data in accordance with the image correction signal.

7. A method for detecting facial areas from images having a relatively light background comprising the steps of:
receiving image data including at least one candidate facial region;
isolating a candidate facial region from received image data;
isolating a subportion of an interior of the candidate facial region;
comparing a size of the subportion relative to a preselected threshold size value;
comparing a luminance value of the subportion with a preselected darkness threshold value; and
generating a facial recognition signal corresponding to a detected facial region in accordance with an output of the size comparison and the luminance comparison.

8. The method of claim 7 further comprising the steps of:
generating histogram data of the subportion;
normalizing the luminance histogram data;
comparing normalized luminance histogram data with the preselected darkness threshold value.

9. The method of claim 8 further comprising the steps of:
generating normalized histogram data from the histogram data;
isolating a mid-point of the normalized histogram data; and
comparing the mid-point to the preselected darkness threshold value.

10. The method of claim 9 further comprising the steps of:
generating the threshold size value in accordance with a plurality of previous facial candidate portion measurements; and
generating the darkness threshold value in accordance with the plurality of previous facial candidate portion measurements.

11. The method of claim 10 further comprising generating an image correction signal in accordance with an output of at least one of the size comparison and the darkness comparison.

12. The method claim 11 further comprising generating adjusted image data corresponding to received image data in accordance with the image correction signal.

13. A system for detecting facial areas from images having a relatively light background comprising:
means adapted for receiving image data including at least one candidate facial region;
means adapted for isolating a candidate facial region from received image data;
means adapted for isolating a subportion of an interior of the candidate facial region;
size comparison means adapted for comparing a size of the subportion relative to a preselected threshold size value;
a luminance comparison means adapted for comparing a luminance value of the subportion with a preselected darkness threshold value; and
means adapted for generating a facial recognition signal corresponding to a detected facial region in accordance with an output of the size comparison means and the luminance comparison means.

14. The system of claim 13 further comprising:
a histogram generator means adapted for generating histogram data of the subportion;
means adapted for normalizing the luminance histogram data; and
wherein the luminance comparison means includes means adapted for comparing normalized luminance histogram data with the preselected darkness threshold value.

15. The system of claim 14 further comprising:
means adapted for generating normalized histogram data from the histogram data;
means adapted for isolating a mid-point of the normalized histogram data; and
wherein the luminance comparison means includes means adapted for comparing the mid-point to the preselected darkness threshold value.

16. The system of claim 15 further comprising:
a threshold size value generator means adapted for generating the threshold size value in accordance with a plurality of previous facial candidate portion measurements; and
a darkness threshold generator means adapted for generating the darkness threshold value in accordance with the plurality of previous facial candidate portion measurements.

17. The system of claim 16 further comprising a correction signal generator means adapted for generating an image correction signal in accordance with an output of at least one of the size comparison means and the darkness comparison means.

18. The system of claim 17 further comprising an image adjustor means adapted for generating adjusted image data corresponding to received image data in accordance with the image correction signal.
